(19) United States
(12) Patent Application Publication
(10) Pub. No.: US 2014/0156048 A1
(43) Pub. Date: Jun. 5, 2014

(54) Integrated Manufacturing and Test Process Platform

(71) Applicant: Spacelabs Healthcare LLC, Snoqualmie, WA (US)

(72) Inventor: Martin Dekker, Bellevue, WA (US)

(73) Assignee: Spacelabs Healthcare LLC, Snoqualmie, WA (US)

(21) Appl. No.: 13/895,281

(22) Filed: May 15, 2013

Related U.S. Application Data
(60) Provisional application No. 61/647,349, filed on May 15, 2012.

(51) Int. Cl. G05B 19/18

(52) U.S. Cl. CPC G05B 19/18
USPC 700/96

(57) ABSTRACT

The present specification provides a novel process platform that replaces paper-based work instructions and data collection used for manufacturing products. Specifically, the present specification provides a method and platform for performing automated testing of a product being manufactured. The process platform of the present invention may be deployed at multiple locations and be integrated with existing quality control systems. The process platform includes a plurality of pre-defined instructions and is programmed to execute these instructions automatically at different stages for performing desired quality checks on the product being manufactured at multiple manufacturing stages.

### CROSS-REFERENCE TO RELATED APPLICATIONS

The present specification relies on U.S. Provisional Patent Application No. 61/647,349, filed on May 15, 2012, for priority.

### FIELD

The present invention relates to the integration of process and quality elements into product realization and/or qualification methods. More particularly, the present invention relates to a process platform fully integrated with manufacturing and quality control element(s) for ensuring quality control of the manufactured products.

### BACKGROUND

During an assembly line manufacturing process, a product is tested for quality at multiple points. Usually the enforcement of quality control is performed manually and hence, is prone to human errors such as erroneous data transcription, missing steps or performing incorrect steps in a testing process, erroneous routing through a process flow, using tools for testing that are out of calibration, performing processes for which the user is not trained, among other mistakes. These errors may result in inaccurate test results being obtained. Further, conveying a product with inaccurate test results to a next manufacturing stage may lead to the production of products that suffer from overall inferior quality.

In the later stages of the product development cycle, qualification tests are conducted to verify design performance and establish limits of process induced performance variability. Creating and implementing these test protocols requires significant time and resources.

Most of the manufacturing systems employing quality control processes suffer from drawbacks, such, as lack of integration of manufacturing management element(s), lack of enforcement of manufacturing management element(s) restrictions, misinterpretation of written instructions, difficult data analyses of manual records, inexact process or design change implementation, change implementation at a remote location requiring local manual intervention, and ill-defined traceability between out-of-tolerance calibrated tools and manufactured products.

Hence, there is a need for automated systems and methods for executing and tracking test results of product units being manufactured during multiple stages of production.

There is also a need for a process platform that seamlessly integrates production processes with testing processes and allows data exchange between the processes without requiring manual intervention.

Further, there is a need for a process platform that replaces paper-based manual assembly and test protocols and supports additional processes such as data definition, assembly and test execution and report analysis for different types of products spread across different business units.

Yet further, there is a need for a reliable process and testing platform providing a reduction in time invested in managing in-bound, execution processes and out-bound data.

Additionally, there is a need for integrating design verification testing and production process quality controls which re-use test protocols and routines initially developed for verification purposes.

### SUMMARY

The present specification describes an automated process platform that integrates an automated quality control testing platform with a manufacturing/production platform for ensuring quality control of the manufactured products.

The automated platform of the present specification comprises a plurality of assembly and test sequences that are executed automatically at predefined stages of the product verification or manufacturing process being implemented by the testing or production platform. In an embodiment, the process platform may be manually configured by using a graphical user interface (GUI). The GUI enables data entry as well as amendment of pre-entered data or test sequences. The process platform may be used for performing quality control checks even at remote locations that are geographically separated from a main data station without requiring an operator for the same at the remote location.

In an embodiment, the present specification provides a new electronic work environment (NEWE) technical user interface and process platform which integrates with existing design and execution platforms, which may, in one embodiment, include design verification, validation and/or qualification elements, to automate and assure quality control at a plurality of stages in a manufacturing process. Information such as design specifications, manufacturing site specifications, manufacturing process variability, testing sequences and manufacturing requirements are input into the NEWE. The NEWE electronically processes the input information and produces information such as test data, process induced performance variation, production results and manufacturing reports. The NEWE also enables equipment tracking throughout the manufacturing process and enforces quality control on the equipment used in the production process. In case of a defect in any of the equipment used, information regarding the products manufactured using the defective equipment may be obtained from an electronic database coupled with the NEWE technical user interface and process platform.

A user may interact with the NEWE database by using a comprehensive GUI which displays required information regarding a manufacturing stage and results of quality control checks performed at the stage.

In one embodiment, the present specification describes a process platform for integrating manufacturing and test process platforms, comprising: a) a manufacturing software subsystem; b) a manufacturing database, in data communication with the manufacturing software subsystem; c) a process design subsystem, in data communication with the manufacturing software subsystem; d) a new electronic work environment technical user interface, coupled to the manufacturing software subsystem; e) at least one display; and f) at least one processor to control the operation of the entire system and its components.

In one embodiment, the manufacturing software subsystem comprises a database that contains manufacturing process software and core system software for controlling manufacturing processes and collecting manufacturing data.

In one embodiment, the manufacturing database is used for housing process parameters for driving manufacturing processes and data collected from the manufacturing processes.

In one embodiment, the process design subsystem is used for storing test sequences and providing a series of instructions to the manufacturing software subsystem to be executed at one or more stages of the manufacturing process.

In another embodiment, the present specification describes a process platform for integrating manufacturing and test process platforms, comprising: a) a manufacturing software subsystem, which comprises a database that contains manufacturing process software and core system software for controlling manufacturing processes and collecting manufacturing data; b) a manufacturing database, in data communication with the manufacturing software subsystem, and used for housing process parameters for driving manufacturing processes and data collected from the manufacturing processes; c) a process design subsystem, in data communication with the manufacturing software subsystem, used for storing test sequences and providing a series of instructions to the manufacturing software subsystem, executed at one or more stages of the manufacturing process; d) an electronic work environment technical user interface, coupled to the manufacturing software subsystem; e) at least one display; and f) at least one processor to control the operation of the entire system and its components.

In one embodiment, the new electronic work environment technical user interface comprises a main interface coupled with the manufacturing software subsystem and is responsible for managing the launching of a manufacturing sequence, synchronizing with the manufacturing sequence, and displaying instructions or results for an operator.

In one embodiment, data is exchanged between the manufacturing software subsystem and the manufacturing database via a database API.

In one embodiment, the process parameters and data collected that are housed within the manufacturing database include at least one of: product lines and definitions, station definitions, user rights definitions, process definitions, or test sequence definitions.

In one embodiment, the process platform further comprises a traceability GUI for handling traceability and tracking definitions and versions of the manufacturing software subsystem, exchanged between the manufacturing database and manufacturing software subsystem.

In one embodiment, the process platform further comprises a publishing GUI for enabling a user to define parameters of the process platform, wherein said parameters include at least one of: assembly details, test details, traceability requirements, or tracking requirements.

In one embodiment, the process platform further comprises an engineering tools GUI for enabling a user to define parameters within the manufacturing software subsystem.

In one embodiment, the process platform further comprises a report viewer for displaying production report results.

In one embodiment, the process platform further comprises a sequence authoring GUI for building and editing test sequences used within the process design subsystem.

In one embodiment, the present specification describes a method for performing automated testing of a product being manufactured at multiple sites of the manufacturing operation, said method being executed by a process platform having at least one computing device executing programmatic instructions stored in non-volatile memory, comprising: a) storing data indicative of a product line in a non-volatile memory; b) storing data indicative of a process for manufacturing said product line in a non-volatile memory; c) storing data indicative of a process for testing said product line in a non-volatile memory, wherein said processes coordinate data flows from a manufacturing software subsystem, a manufacturing database, and a process design subsystem; and d) automatically executing quality control and process flow procedures stored in a non-volatile memory at predefined stages of a manufacturing process being executed by the process platform.

In one embodiment, the manufacturing software subsystem comprises a database that contains manufacturing process software and core system software for controlling manufacturing processes and collecting manufacturing data.

In one embodiment, the manufacturing database houses process parameters for driving manufacturing processes and data collected from the manufacturing processes.

In one embodiment, the process design subsystem stores test sequences and provides a series of instructions to the manufacturing software subsystem that are executed at one or more stages of the manufacturing process.

In one embodiment, the method further includes tracking equipment used in the manufacturing process by automatically monitoring quality parameters of the equipment.

In one embodiment, the method further includes a means for integrating a main production site with a plurality of remote production sites.

In one embodiment, the method further includes a means for implementing quality control procedures at a plurality of remote production sites integrated with a main production site.

In one embodiment, the present specification discloses a system for managing a quality control process, comprising: a plurality of programmatic instructions stored in non-volatile memory, wherein said programmatic instructions, when executed by a processor, cause a first graphical user interface to be displayed on a screen; receiving data indicative of a quality level of a component; a plurality of programmatic instructions stored in non-volatile memory, wherein said programmatic instructions, when executed by a processor, determine if said quality level meets a threshold level; a plurality of programmatic instructions stored in non-volatile memory, wherein said programmatic instructions, when executed by a processor, causes a second graphical user interface to be displayed on a screen, wherein said second graphical user interface comprises a rework option; and a plurality of programmatic instructions stored in non-volatile memory, wherein said programmatic instructions, when executed by a processor, causes said component to be disassembled based upon a selection of said rework option.

In another embodiment, the present specification discloses a system for managing a quality control process, comprising: a plurality of programmatic instructions stored in non-volatile memory, wherein said programmatic instructions, when executed by a processor, cause a first graphical user interface to be displayed on a screen; receiving data indicative of a quality level of a component, wherein said quality level comprises a qualitative quality level and a quantitative quality level; a plurality of programmatic instructions stored in non-volatile memory, wherein said programmatic instructions, when executed by a processor, determine if said quality level meets a threshold level; a plurality of programmatic instructions stored in non-volatile memory, wherein said programmatic instructions, when executed by a processor, causes a second graphical user interface to be displayed on a screen, wherein said second graphical user interface comprises a retry option, wherein said retry option is only selectable or displayed if said component is not assembled; and a plurality of programmatic instructions stored in non-volatile memory, wherein said programmatic instructions, when executed by a processor, causes said quality level checks to be performed again on said component based upon a selection of said retry option.

The aforementioned and other embodiments of the present shall be described in greater depth in the drawings and detailed description provided below.

### BRIEF DESCRIPTION OF THE DRAWINGS

These and other features and advantages of the present invention will be further appreciated, as they become better understood by reference to the detailed description when considered in connection with the accompanying drawings:

FIG. 1 illustrates a block diagram of a Process Platform, in accordance with an embodiment of the present invention;

FIG. 2 illustrates a New Electronic Work Environment (NEWE) Graphical User Interface (GUI) context for the process platform described in FIG. 1 and in accordance with an embodiment of the present invention;

FIG. 3A illustrates an exemplary graphic of a NEWE GUI, in accordance with an embodiment of the present invention;

FIG. 3B illustrates another exemplary graphic of a NEWE GUI, in accordance with an embodiment of the present invention;

FIG. 4A illustrates the stages of quality control conventionally implemented conventionally during a product manufacturing process;

FIG. 4B illustrates the stages of quality control implemented during a product manufacturing process, in accordance with an embodiment of the present invention;

FIG. 5A illustrates the steps of a manufacturing process implementing conventional methods of quality control;

FIG. 5B illustrates the steps of a manufacturing process implementing the NEWE process platform in accordance with an embodiment of the present invention;

FIG. 5C is a diagrammatic representation of input to and output from the NEWE process platform, in accordance with an embodiment of the present invention;

FIG. 6 is a diagrammatic illustration of the integrated process platform interfacing with a main location and a plurality of remote locations, in accordance with an embodiment of the present invention; and

FIG. 7 is a block diagram illustrating a hardware configuration of the NEWE technical user interface in which a main site is integrated with a remote site, in accordance with an embodiment of the present invention.

### DETAILED DESCRIPTION

The present specification provides a novel process platform for replacing paper-based manual test platforms, paper-based work instructions, travellers, and data collection used for manufacturing products. Additionally, the present specification enables the close integration of verification or qualification tests with the application and enforcement of quality control steps in the execution process. In various embodiments, the architecture of the process platform supports data definition, product assembly and test execution and report analysis for different types of products spread across a single or multiple business unit(s). Further, in various embodiments, operators interact with the process platform through a touch-screen based graphical user interface (GUI) and a barcode or RFID scanner. This functionality replaces operator interaction with work instructions and travellers of a paper based system, thereby reducing errors in quality testing and enforcing a strict quality control.

The process platform described in the present specification addresses the drawbacks of a conventional assembly and test process used in conjunction with a manufacturing process by providing integration of quality and manufacturing management element(s), and enforcing quality and manufacturing management element(s) restrictions. The process platform also allows transfer of quality and manufacturing data and test sequences between a data center and one or more remote production sites, providing implementation of a change at a remote location without any local manual intervention.

The process platform of the present specification is coupled to at least one display, which displays information about each component within the system and the functioning of the system, by means of a GUI. The GUI also presents various menus that allow users to configure settings according to their requirements. The platform further comprises at least one processor to control the operation of the entire system and its components. It should further be appreciated that the at least one processor is capable of processing programmatic instructions, has a memory capable of storing programmatic instructions, and employs software comprised of a plurality of programmatic instructions for performing the processes described herein. In one embodiment, the at least one processor is a computing device capable of receiving, executing, and transmitting a plurality of programmatic instructions stored on a volatile or non-volatile computer readable medium.

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

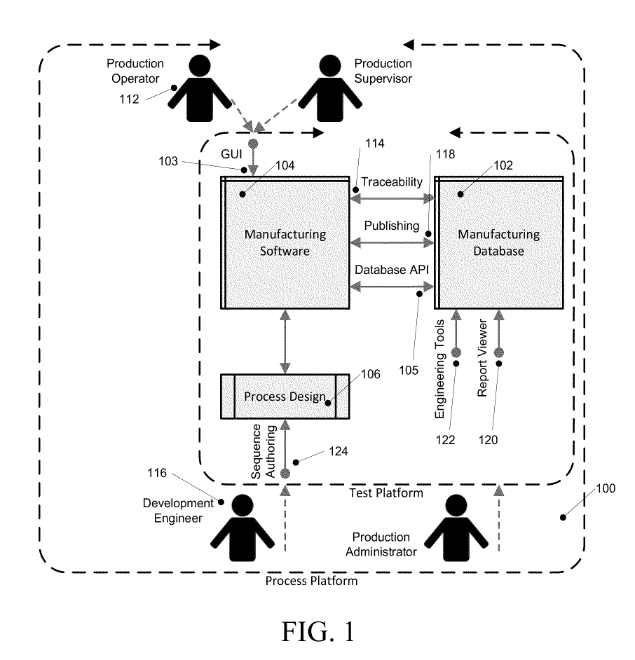

FIG. 1 illustrates a block diagram of the novel process platform, in accordance with an embodiment of the present invention. As illustrated, the Process Platform 100 is a test platform that comprises a database subsystem 102, which in one embodiment is a Manufacturing Database, a Manufacturing Software subsystem 104 and a Process Design software subsystem 106.

In an embodiment, the Manufacturing Database subsystem 102 is a database which contains process parameters used to drive manufacturing processes as well as data collected from manufacturing processes. Thus, the Manufacturing Database 102 is a clearinghouse for storing information related to manufacturing processes. The Manufacturing Software subsystem 104 is a database which contains manufacturing process software; graphics used in a new electronic work environment technical user interface (NEWE GUI); and the core system software allowing the manufacturing processes to be controlled and manufacturing data to be collected. Communication between the two subsystems occurs by means of an abstract software communication layer. The Process Design subsystem 106 is a commercial off-the-shelf (COTS) programming environment, and communicates to the Manufacturing Software subsystem 104 by means of uploading its native format files.

A plurality of interfaces is provided to enable user interaction within the subsystems of the process platform 100 of the present invention. In one embodiment, sequence authoring is employed where data is manually input into a software application, such as a word processing or spreadsheet application. In one embodiment, a graphical user interface is employed which involves the exchange of XML files, driven by events such as commencing a manufacturing process, publishing a new process revision, etc. Specific embodiments of interfaces are described with greater detail below.

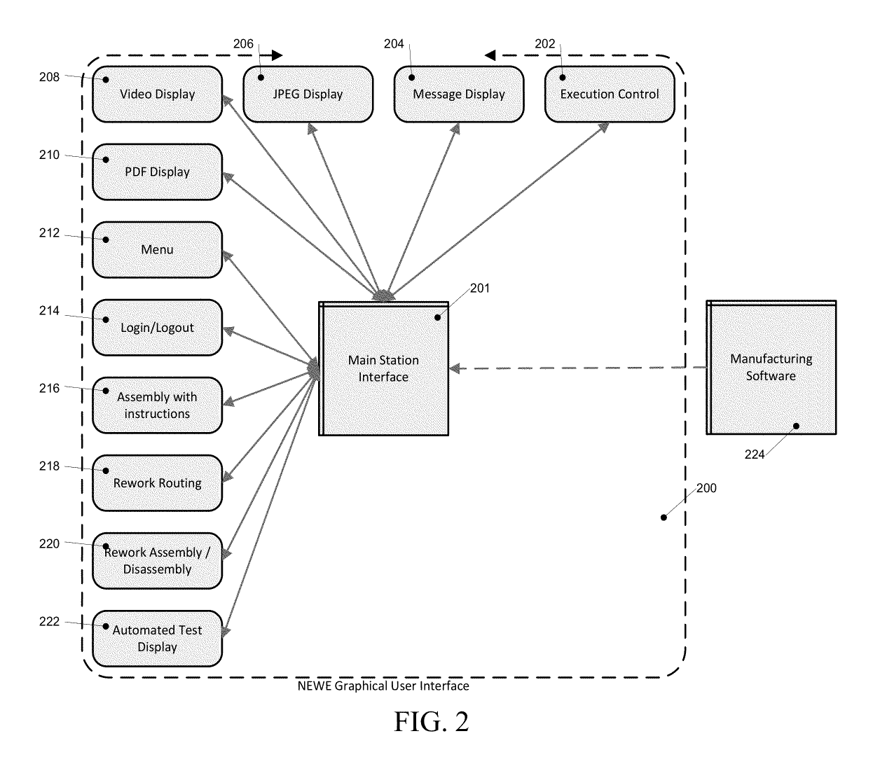

In an embodiment, at least one user interface of the Process Platform 100 comprises a graphical user interface (GUI) 103, coupled to the Manufacturing Software subsystem 104, and is principally used by an operator 112 of the Process Platform 100. In one embodiment, GUI 103 is a New Electronic Work Environment (NEWE) technical user interface which is responsible for managing the launching of a Manufacturing Sequence, which includes both assembly and test processes; synchronizing with the Manufacturing Sequence; and displaying instructions or results for the operator, and is described in greater detail below with respect to FIG. 2.

A Traceability API/GUI 114 is provided for handling traceability (association of part identification and part data with the product data); tracking (association of unique part identification with the product data) definitions; and creating versions of the Manufacturing Software subsystem 102 and is principally used by an engineer 116 for defining the traceability and the tracking of parts and products being manufactured and tested by the Process Platform 100. The Traceability API/GUI 114 enables data communication between Manufacturing Software subsystem 104 and Manufacturing Database 102 and ensures that unique part data is linked with the product data to form a complete product data set representing all quality elements of the product.

A Publishing API/GUI 118 is provided for enabling an engineer to define parameters of the Process Platform 100, such as assembly details, test details, traceability and tracking requirements. It constitutes the action of launching the new process design into operation, accomplished by replacement of the existing parameters with new parameters by defining data exchange between the Manufacturing Software subsystem 104 and Manufacturing Database 102.

A database API 105 forms the abstract software communication layer through which data is exchanged; thus, via database API 105, process parameters are collected from the Manufacturing Database 102 and test results get stored back into the Manufacturing Database 102.

An Engineering Tools GUI 122 is provided for defining parameters within the manufacturing database 102, typically used by an engineer.

A Report Viewer 120 is an application provided for displaying production report results that are generated by the Manufacturing Database 102.

A Sequence Authoring GUI 124 is provided to build and edit process design, for process design subsystem 106, typically used by an engineer. Sequence authoring involves manual data input into a commercial off-the-shelf (COTS) software application. Process Design subsystem 106 provides a series of instructions to the manufacturing software subsystem 104, each containing a different set of data elements such as, but not limited to, TQC type, control limits, and Units of Measure.

Process Design subsystem 106 is in data communication with manufacturing software 104, by means of manual uploading of its native format files.

In various embodiments, the manufacturing database 102 may be obtained as a software package from those that may be well-known to those of skill in the art. In an embodiment the Manufacturing Database 102 comprises definitions such as product lines and definitions, station definitions, user rights definitions, process definitions and test sequences definitions that are required for the functioning of the process platform 100.

In various embodiments, the process platform 100, and more specifically, the Manufacturing Database 102 comprises a list of valid products within an organization that are manufactured and subsequently tested, along with their definitions. In an embodiment, the valid products are divided into various product lines, as may be appropriate to the organization that is implementing the process platform. By way of example only, in one embodiment, the product lines may include product lines such as, but not limited to anesthesia delivery and ventilation (AD&V), patient monitoring and connectivity (PM&C), and diagnostic cardiology (DC), each having their specific products associated with that product line.

In an embodiment, process definitions are provided by using a set of structures and rules. In an embodiment, processes are separated by line, group, and sub-group. A sub-group comprises valid product types that share the same process. In an embodiment, the processes are defined in a Sequence of Execution (SOE) module. The SOE module also comprises operation definitions. By way of example only, operations defined in the SOE may include a “Ready” and a “Rework” operation. Each operation defined in the SOE has various characteristics which provide enforcement of manufacturing process. In an embodiment, each operation has a “Fail-transition to the Rework operation” and “Pass-transition between operations” which further enforces the process flow defined in the SOE.

In an embodiment, a publishing repository, housed within Manufacturing Database 102, manages data to be deployed on any remote station where a product requiring the implementation of process(es) described herein is being manufactured. The Manufacturing Database 102 also contains test results and an analysis module which includes formatted information for producing one or more manufacturing and testing reports. The traceability module defines assembly rules that permit multiple products being manufactured to be linked.

In one embodiment, the process platform of the present specification comprises a New Electronic Work Environment (NEWE) technical user interface. In various embodiments, the NEWE Graphical User Interface (GUI) is responsible for managing the launching of a Manufacturing Sequence, synchronizing with the Manufacturing Sequence, and displaying instructions or results for the operator. Design specifications may be input into the NEWE interface whereby work instructions and work orders may be electronically produced thereby eliminating a plurality of manual errors.

FIG. 2 illustrates an NEWE User Interface flow context, in accordance with an embodiment of the present invention. As illustrated, the NEWE Graphical User Interface (GUI) 200 is an executable available on the process platform of the present invention, and is the main interface used by operators. Thus, a process operator, as shown in FIG. 1, can use the NEWE GUI of the present invention to interface with manufacturing software subsystem 104. Referring back to FIG. 2, in an embodiment, the NEWE GUI 200 is deployed via a publishing module, which enables an engineer to define parameters of the Process Platform, such as assembly details, test details, traceability and tracking requirements.

In an embodiment, exemplary features of the NEWE GUI 200 include network accessibility between the Manufacturing Software subsystem 224 and the Main Station Interface 201 on the station where it runs, which are easily usable with a touch screen display and a size of 1920×1080 pixels.

In an embodiment, a Main Station Interface 201 of the NEWE GUI 200 is coupled with a module for controlling execution of manufacturing sequences 202 and at least one module 204 for message display 204, which allows for process platform messaging to the user. Also included are image display 206, video display 208, and display of .pdf files 210 which allow graphic images to be retrieved from the test package and displayed to the operator. In one embodiment, the NEWE also includes a module 212 for displaying a menu; a login/logout module 214 which verifies operator identification and ensures that the system is accessed with permission only; an assembly module 216, which provides assembly instructions for a particular part; a rework routing module 218 which routes specific parts or assemblies to a rework function if the quality step or functional test does not meet specification; a rework assembly/disassembly module 220 allowing tracking of sub-assemblies or parts during a disassembly or repair process; and an auto test display module 222 which initiates or displays execution results from an automated testing sub-routine. In one particular embodiment, all of the above-mentioned modules are created through Manufacturing Software control 224.

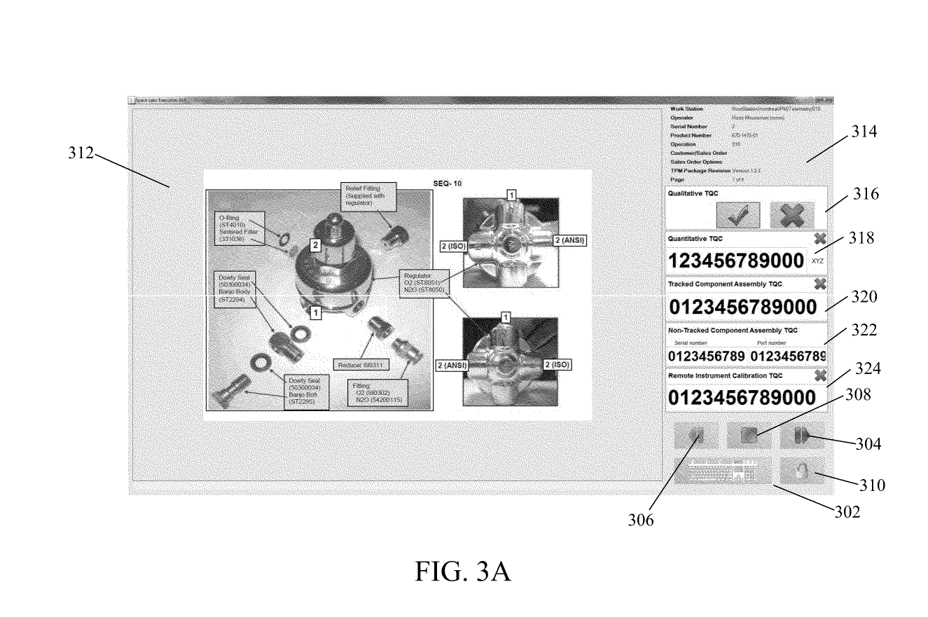

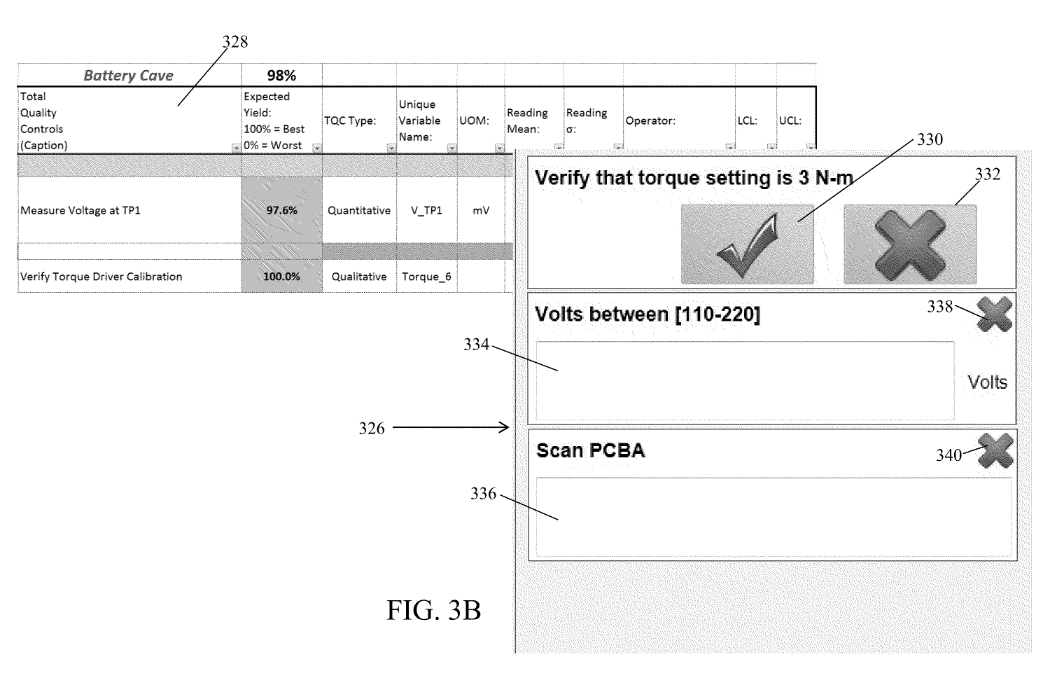

FIG. 3A illustrates an exemplary instance of the NEWE GUI, in accordance with an embodiment of the present invention. As illustrated, section 302 of the GUI provides a back button 306, a next button 304 and a stop button 308. These buttons allow the operator to go back and forth through multiple sections of a production sequence. The back button 306 may be disabled while configuring an automated test sequence. In an embodiment, the next button 304 is enabled only when an ‘End Section’ step is executed in the test sequence. Upon pressing the next button 304, the system executes a verification step to validate that the result of any total quality check (TQC) performed earlier is ‘pass’. If the result is a “no pass”, a pop-up is displayed to a user to indicate that the product is failing the test and ask for confirmation if the user wants to continue. If the user clicks on a ‘Yes’ button, the sequence fails and the number of retry attempts is logged. The maximum number of times a user is permitted to retry is predefined. In an embodiment, upon pressing the back button 306, a previous set of TQC values are saved in the Test Database but are not displayed on the NEWE GUI, thereby prompting a user to enter new values for the page. Further, in an embodiment, if a component has already been assembled, the user is not permitted to disassemble it by using the NEWE GUI. The disassembly may be performed by initiating a ‘Rework’ operation. The stop button 308 allows the operator to stop the execution of a test sequence with a ‘Terminated’ which, in an embodiment, is not considered as a ‘Fail’ state. Further, in an embodiment, a lock button 310 allows an operator to stop and lock the execution of the NEWE GUI when the operator has to leave the station. The locked test sequence may then be unlocked only upon entering a predefined valid password.

In an embodiment, when a new product unit is scanned by using the process platform of the present invention, the NEWE GUI creates the unit record in the Manufacturing Database, and commences the execution of a predefined sequence corresponding to the unit. As illustrated the NEWE GUI may display an image (.jpg file), a video (.avi file) or a .pdf file in section 312. Section 314 of the NEWE GUI displays information such as work station identification, operator identification, a serial number and a product number of the unit being tested, an operation identification code, a published package identification and a page number. In an embodiment, a Sales Order number and Sales Order options value are obtained from an operator and are also displayed in section 314. In an embodiment, the NEWE GUI also provides a display to allow assembly and disassembly of already assembled subcomponents during a ‘Rework’ operation.

In an embodiment of the present invention, five types of TQCs are predefined. A Qualitative TQC is displayed in section 316 with a description and two buttons depicting a pass and a fail result. A Quantitative TQC is displayed in section 318 with a description and a text box to enter a value of Numeric Limit Test result. A Tracked Component Assembly TQC is displayed in section 320 with a description as well a text box to scan a unit (the bar code containing the serial number and the part number). In an embodiment, the result is ‘Pass’ if the unit exists in the Manufacturing Database, is in a ‘Ready’ operation, is not already assembled, and if both a Top (parent) product/component and a child product/component of the unit have the same Sales Order number. A Non-Tracked Component Assembly TQC is displayed in section 322 for entering a serial number and the part number of the unit being tested. A Remote Instrument Calibration TQC is displayed in section 324 with a description and a text box to enter an Asset number of the unit being tested.

In various embodiments, a test sequences module can be launched from the NEWE GUI using an Execution Control component (202 in FIG. 2). In an embodiment, a test sequence may be an automated test sequence, containing calls to instruments and algorithm or manual instruction sequences, calling the NEWE GUI Control API. This system also includes interaction with the Manufacturing Database as it implies rules for the Test Sequences creation.

FIG. 3B illustrates an instance of the NEWE GUI, in accordance with an embodiment of the present invention. The illustrated GUI 326 displays information regarding total quality control (TQC) 328 of a unit of product being manufactured. Thus, TQC information that is generally presented in the form of a spreadsheet is transferred to and presented in the form of a GUI 326. Buttons bearing graphical images 330 and 332 enable a user to confirm or deny presented information, respectively. For example, as illustrated, a user is required to confirm if a torque value is set at 3 N-m. The user may click on button 330 to confirm the torque value or button 332 to deny the torque setting. A user may enter information regarding a voltage value corresponding to the torque value by using text box 334 and a scan PCBA value using text box 336. Buttons 338, 340 bearing a cross or a tick mark is provided adjacent the text boxes 334, 336, respectively, to enable a user to obtain a fail or a pass test value.

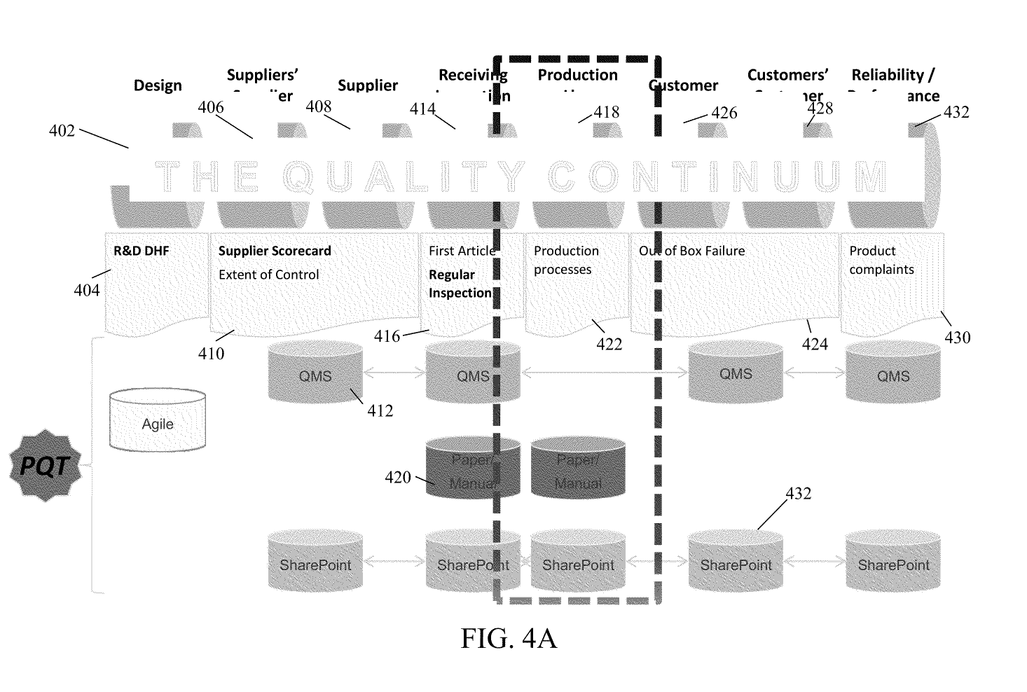

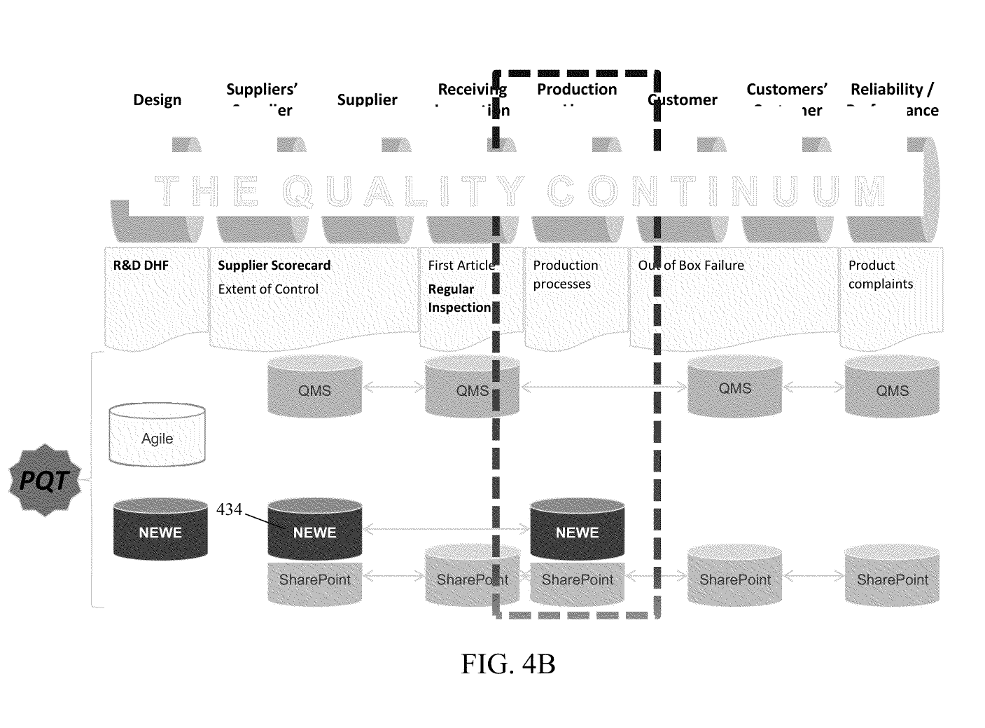

FIG. 4A illustrates the stages of quality control conventionally implemented during product manufacturing. As illustrated, a manufacturing process is initiated with the production of a design document 402 which is usually produced by a Research and Development (R&D) team. As is known in the art, especially in cases of manufacturing medical devices, a Design History File (DHF) 404 is created with respect to each new design and this DHF serves as a means of defining quality control of the manufactured medical device at a design stage. As a next stage of product manufacture, materials predefined at the design stage 402 are obtained from suppliers 408 who in turn obtain it from other suppliers 406 (suppliers' supplier). A quality check at this stage may be applied by using a past performance record or a supplier's score card 410 in conjunction with a quality management system (QMS) 412 which may be described as an organizational structure, and includes procedures, processes and resources needed to implement quality. Usually the QMS 412 is a manual and paper-based system and is hence prone to human errors. Once a first article is manufactured, a quality check is performed on the first article 414 as part of a regular manual inspection 416 by using existing paper/manual QMS 412. At a next stage where a larger volume production line, 418, manufacturing of the product is performed, one or more paper/manual based quality checks 420 are performed as part of the predefined production process 422. Further, conventionally, the paper or manual based QMS 412 is also used to implement quality control when an out of box failure 424 of the product occurs at a customer site 426 or a customers' customer site 428. Next, to deal with subsequent product complaints 430 made by users a reliability/performance process 432 which may be a part of the QMS 412 is conventionally implemented. A business collaboration program such as SharePoint 432 may also be used to aid, among other aspects, quality control management in the manufacturing process.

FIG. 4B illustrates the stages of quality control implemented during manufacturing of a product, in accordance with an embodiment of the present invention. As illustrated, the process platform provided by the present invention comprising NEWE 434 GUI as described above is implemented within the existing quality control framework illustrated in FIG. 4A. Hence, by using the NEWE 434, the manual/paper based quality control checks are replaced with automated testing sequences and electronically defined process instructions, process flow and unit data collection. In various embodiments, initial design specifications along with desired quality checks and controls may be established at a commencement stage of the manufacturing process. Additionally, NEWE may be used to create or establish limits for the quality checks based upon process variation found during the verification tests found during the design phase. Further, the NEWE 434 may iteratively evolve and re-design the quality checks based on input received at each stage of the manufacturing process. Such inputs may be fed manually or via electronic means to the NEWE 434 for automating the quality control management of the manufacturing process. Further, the NEWE 434 enables integration of quality control test sequences with the entire design and manufacturing process.

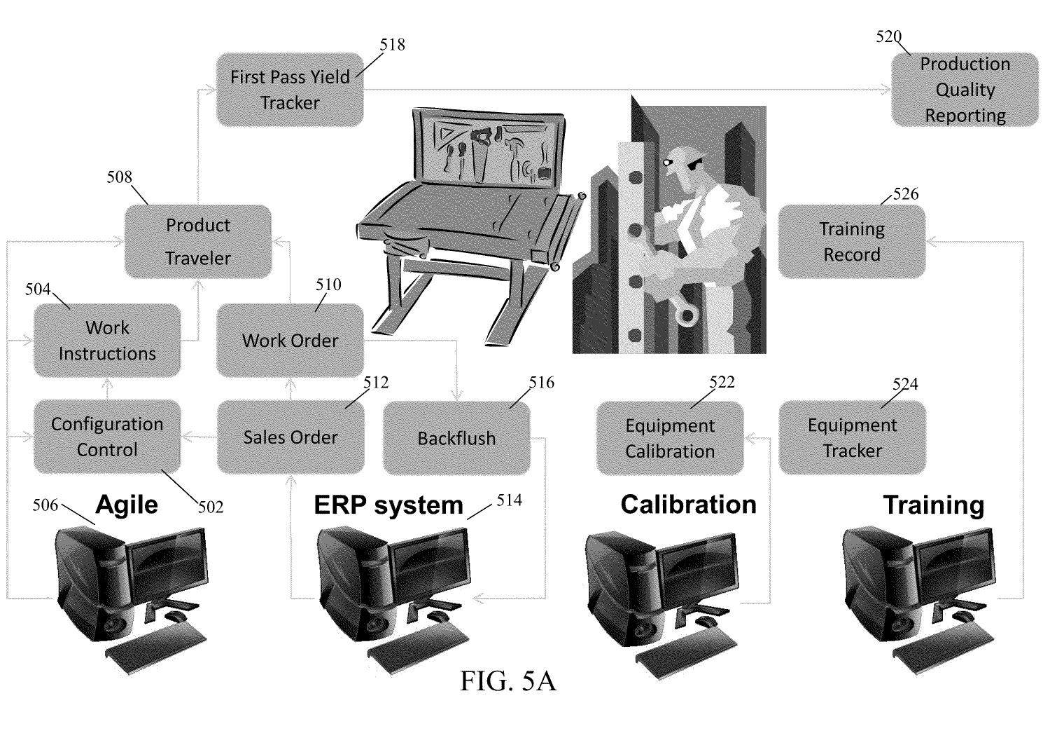

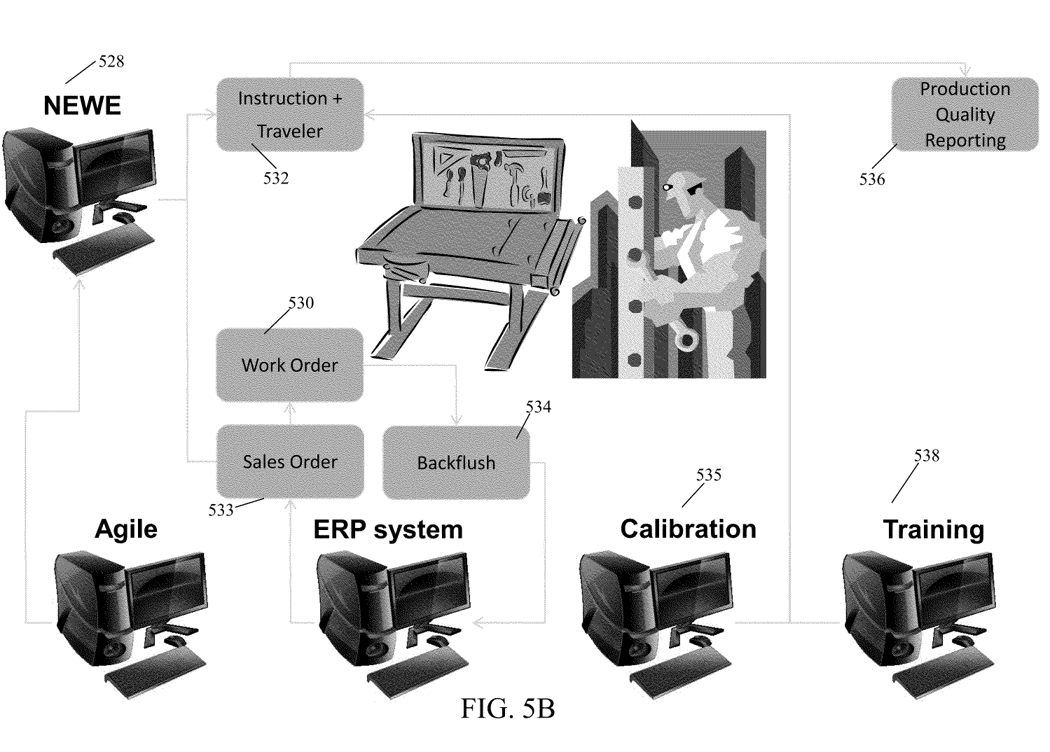

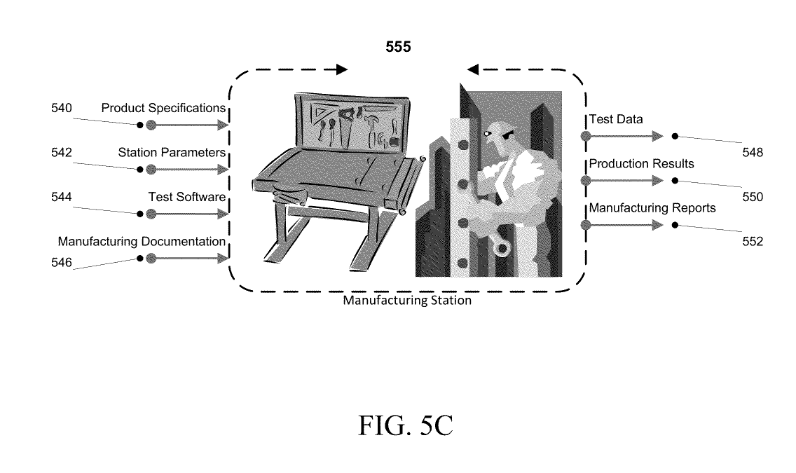

FIG. 5A illustrates the steps of a manufacturing process implementing conventional methods of quality control. Product travellers 508 are created using configuration tools 502 and work instructions 504 on a development platform such as Agile 506, which comprises software and methods based on iterative and incremental development where requirements and solutions evolve through collaboration between self-organizing, cross-functional teams. Conventionally, product travellers 508 contain a set of products that need to be created and the steps that are to be followed to create those products, and hard copies of such travellers 508 are passed from one workstation to another during execution of a manufacturing process. The product traveller 508 is created and iteratively revised upon receiving inputs from the work instruction 504, the Agile platform 506, and a work order 510 which, in turn, is created as a consequence of a sales order 512 developed as part of predefined manufacturing requirements 514. Further, as illustrated a backflush 516 of raw materials, etc. obtained from the work order 510 are re-processed by the ERP system 514 and incorporated in to the sales order 512. A first pass yield tracker 518 is used to monitor the quality of the manufactured products for creating a production quality report 520 by using manual and paper based tools. Further, equipment calibration 522, equipment tracking 524 and maintaining training records 526 are all performed as independent activities with independent quality control procedures, which are not integrated with the entire manufacturing process.

FIG. 5B illustrates the steps of a manufacturing process implementing the NEWE process platform, in accordance with an embodiment of the present invention. As illustrated, a NEWE process platform 528 interfaces with the Agile development platform 506, the manufacturing process, as well as calibration and training processes, thereby producing electronic work orders 530, product travellers 532, sales orders 533, backflush 534, equipment calibration 535, production quality reports 536, and training records 538. The use of the NEWE process platform 528 ensures automatic enforcement of quality standards as quality control test sequences are fully integrated with design as well as implementation stages of the manufacturing process. Design specifications may be input into the NEWE process platform 528, whereby work instructions and work orders may be electronically produced thereby eliminating a plurality of manual errors. Further, by using the NEWE process platform 528 of the present invention, equipment used in the manufacturing process may be tracked electronically so that if there is a defect in the equipment, an exact number and identification codes of the products that have been manufactured by using the defective equipment may be made automatically.

FIG. 5C is a diagrammatic representation of the input and output of the NEWE test platform, in accordance with an embodiment of the present invention. As illustrated, desired product specification 540, desired station/site parameters 542, test software 544, and other required manufacturing documentation 546 is input to the NEWE platform 555. The input information is processed electronically by the NEWE platform 555 to automatically output test data 548, production results 550 and manufacturing reports 552.

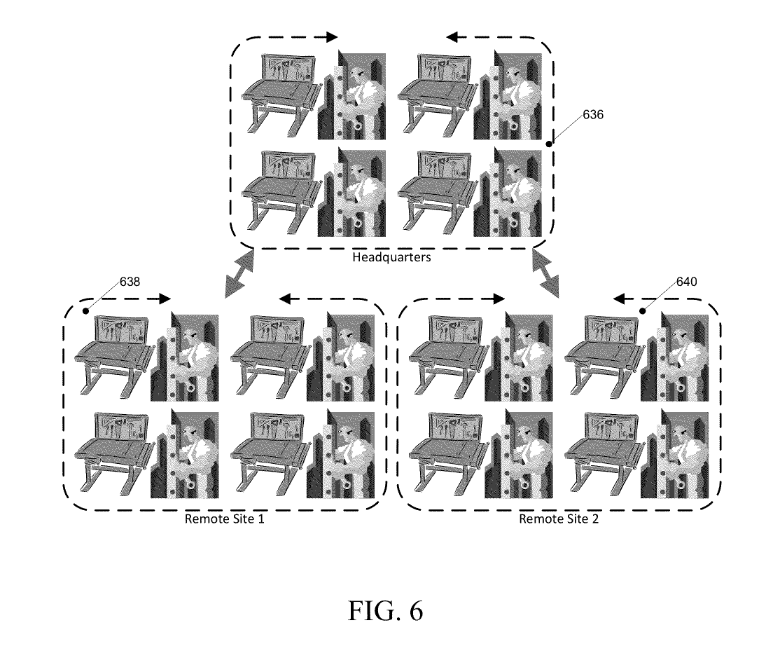

FIG. 6 is a diagrammatic illustration of the integrated process platform interfacing with a main location and a plurality of remote locations, in accordance with an embodiment of the present invention. As illustrated, a main location running a manufacturing database center 636 with a plurality of remote manufacturing locations such as remote site 1 638 and remote site 2 640, by using the integrated process platform of the present invention. Each remote site has at least one process platform unit operating using the NEWE GUI.

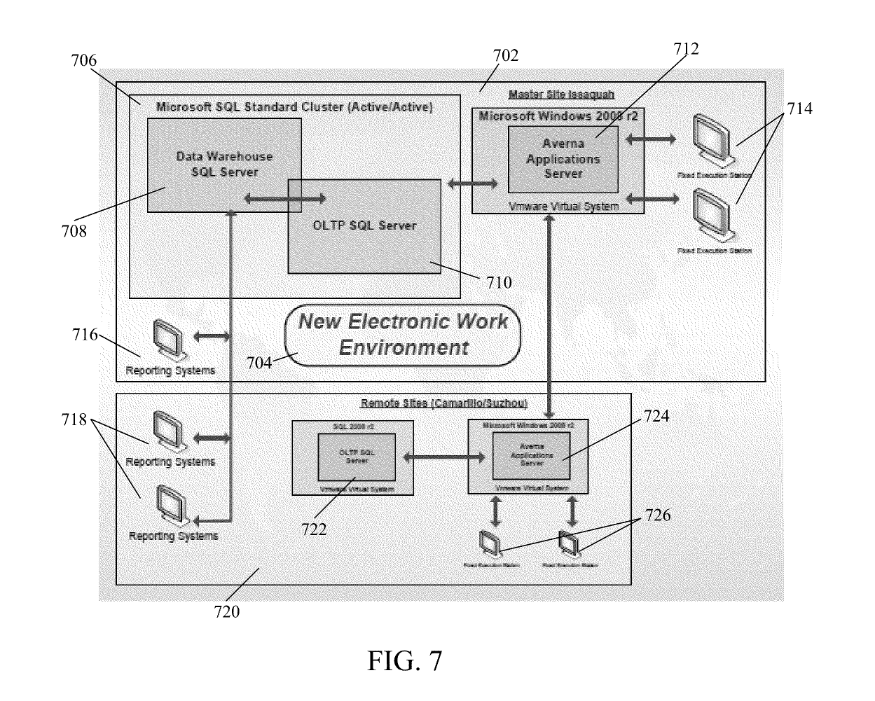

FIG. 7 is a block diagram illustrating a hardware configuration of the NEWE integrating a main site with a remote site, in accordance with an embodiment of the present invention. A main site 702 employing the NEWE test platform 704 comprises a Microsoft SQL standard cluster 706 comprising a data warehouse 708 and an online transaction processing (OLTP) module 710. The main site 702 also comprises an application server 712 for coupling a plurality of fixed work stations 714 at the main site 702 with the Microsoft SQL standard cluster 706. The data warehouse 708 stores manufacturing data such as design specification, work instructions etc., and the OLTP module 710 processes the stored data. The data warehouse 708 is also coupled with a plurality of reporting stations 716 at the main site 702 as well as a plurality of reporting stations 718 deployed at a remote site 720. The remote site 720 also comprises an OLTP server 722 coupled with an application server 724 which in turn is coupled with a plurality of fixed work stations 726. The application server 712 deployed at the main site 702 is coupled with the application server 724 deployed at the remote site 720, thereby allowing automatic updating of any changes implemented locally at the remote site 720 to the main site 702.

The present specification describes a novel process platform that replaces paper-based work instructions, travellers, and data collection used for manufacturing products. The present specification provides a method and platform for performing automated testing of a product being manufactured at multiple sites of the manufacturing operation. The process platform of the present invention may be deployed at multiple locations and be integrated with existing quality control systems. The process platform comprises a plurality of pre-defined instructions and is programmed to execute these instructions automatically at different stages for performing desired quality checks on the product being manufactured at multiple manufacturing stages.

The above examples are merely illustrative of the many applications of the system of present invention. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

We claim:

1. A process platform for integrating manufacturing and test process platforms, comprising:
a. a manufacturing software subsystem, which comprises a database that contains manufacturing process software and core system software for controlling manufacturing processes and collecting manufacturing data;
b. a manufacturing database, in data communication with the manufacturing software subsystem, and used for housing process parameters for driving manufacturing processes and data collected from the manufacturing processes;
c. a process design subsystem, in data communication with the manufacturing software subsystem, used for storing test sequences and providing a series of instructions to the manufacturing software subsystem, executed at one or more stages of the manufacturing process;
d. an electronic work environment technical user interface, coupled to the manufacturing software subsystem;
e. at least one display; and
f. at least one processor to control the operation of the entire system and its components.

2. The process platform of claim 1 wherein the new electronic work environment technical user interface comprises a main interface coupled with the manufacturing software subsystem and is responsible for managing the launching of a manufacturing sequence, synchronizing with the manufacturing sequence, and displaying instructions or results for an operator.

3. The process platform of claim 1 where data is exchanged between the manufacturing software subsystem and the manufacturing database via a database API.

4. The process platform of claim 1 wherein the process parameters and data collected that are housed within the manufacturing database include at least one of: product lines and definitions, station definitions, user rights definitions, process definitions, or test sequence definitions.

5. The process platform of claim 1 further comprising a traceability GUI for handling traceability and tracking definitions and versions of the manufacturing software subsystem, exchanged between the manufacturing database and manufacturing software subsystem.

6. The process platform of claim 1 further comprising a publishing GUI for enabling a user to define parameters of the process platform, wherein said parameters include at least one of: assembly details, test details, traceability requirements, or tracking requirements.

7. The process platform of claim 1 further comprising an engineering tools GUI for enabling a user to define parameters within the manufacturing software subsystem.

8. The process platform of claim 1 further comprising a report viewer for displaying production report results.

9. The process platform of claim 1 further comprising a sequence authoring GUI for building and editing test sequences used within the process design subsystem.

10. A process platform for integrating manufacturing and test process platforms, comprising:
a. a manufacturing software subsystem;
b. a manufacturing database, in data communication with the manufacturing software subsystem;
c. a process design subsystem, in data communication with the manufacturing software subsystem;
d. a new electronic work environment technical user interface, coupled to the manufacturing software subsystem;
e. at least one display; and
f. at least one processor to control the operation of the entire system and its components.

11. The process platform of claim 10 wherein the manufacturing software subsystem comprises a database that contains manufacturing process software and core system software for controlling manufacturing processes and collecting manufacturing data.

12. The process platform of claim 10 wherein the manufacturing database is used for housing process parameters for driving manufacturing processes and data collected from the manufacturing processes.

13. The process platform of claim 10 wherein the process design subsystem is used for storing test sequences and providing a series of instructions to the manufacturing software subsystem to be executed at one or more stages of the manufacturing process.

14. The process platform of claim 10 wherein the new electronic work environment technical user interface comprises a main interface coupled with the manufacturing software subsystem and is responsible for managing the launching of a manufacturing sequence, synchronizing with the manufacturing sequence, and displaying instructions or results for an operator.

15. The process platform of claim 10 where data is exchanged between the manufacturing software subsystem and the manufacturing database via a database API.

16. The process platform of claim 10 wherein the process parameters and data collected that are housed within the manufacturing database include at least one of: product lines and definitions, station definitions, user rights definitions, process definitions, or test sequence definitions.

17. The process platform of claim 10 further comprising a traceability GUI for handling traceability and tracking definitions and versions of the manufacturing software subsystem, exchanged between the manufacturing database and manufacturing software subsystem.

18. The process platform of claim 10 further comprising a publishing GUI for enabling a user to define parameters of the process platform, wherein said parameters include at least one of: assembly details, test details, traceability requirements, or tracking requirements.

19. The process platform of claim 10 further comprising an engineering tools GUI for enabling a user to define parameters within the manufacturing software subsystem.

20. The process platform of claim 10 further comprising a report viewer for displaying production report results.

21. The process platform of claim 10 further comprising a sequence authoring GUI for building and editing test sequences used within the process design subsystem.

22. A method for performing automated testing of a product being manufactured at multiple sites of the manufacturing operation, said method being executed by a process platform having at least one computing device executing programmatic instructions stored in non-volatile memory, comprising:
a. storing data indicative of a product line in a non-volatile memory;
b. storing data indicative of a process for manufacturing said product line in a non-volatile memory;
c. storing data indicative of a process for testing said product line in a non-volatile memory, wherein said processes coordinate data flows from a manufacturing software subsystem, a manufacturing database, and a process design subsystem; and
d. automatically executing quality control and process flow procedures stored in a non-volatile memory at predefined stages of a manufacturing process being executed by the process platform.

23. The method of claim 22 wherein the manufacturing software subsystem comprises a database that contains manufacturing process software and core system software for controlling manufacturing processes and collecting manufacturing data.

24. The method of claim 22 wherein the manufacturing database houses process parameters for driving manufacturing processes and data collected from the manufacturing processes.

25. The method of claim 22 wherein the process design subsystem stores test sequences and provides a series of instructions to the manufacturing software subsystem that are executed at one or more stages of the manufacturing process.

26. The method of claim 22 wherein said method further includes tracking equipment used in the manufacturing process by automatically monitoring quality parameters of the equipment.

27. The method of claim 22 wherein said method further includes a means for integrating a main production site with a plurality of remote production sites.

28. The method of claim 27 wherein said method further includes a means for implementing quality control procedures at a plurality of remote production sites integrated with a main production site.

29. A system for managing a quality control process, comprising:
a plurality of programmatic instructions stored in non-volatile memory, wherein said programmatic instructions, when executed by a processor, cause a first graphical user interface to be displayed on a screen;
receiving data indicative of a quality level of a component;
a plurality of programmatic instructions stored in non-volatile memory, wherein said programmatic instructions, when executed by a processor, determine if said quality level meets a threshold level;
a plurality of programmatic instructions stored in non-volatile memory, wherein said programmatic instructions, when executed by a processor, causes a second graphical user interface to be displayed on a screen, wherein said second graphical user interface comprises a rework option; and
a plurality of programmatic instructions stored in non-volatile memory, wherein said programmatic instructions, when executed by a processor, causes said component to be disassembled based upon a selection of said rework option.

30. A system for managing a quality control process, comprising:
a plurality of programmatic instructions stored in non-volatile memory, wherein said programmatic instructions, when executed by a processor, cause a first graphical user interface to be displayed on a screen;
receiving data indicative of a quality level of a component, wherein said quality level comprises a qualitative quality level and a quantitative quality level;
a plurality of programmatic instructions stored in non-volatile memory, wherein said programmatic instructions, when executed by a processor, determine if said quality level meets a threshold level;
a plurality of programmatic instructions stored in non-volatile memory, wherein said programmatic instructions, when executed by a processor, causes a second graphical user interface to be displayed on a screen, wherein said second graphical user interface comprises a retry option, wherein said retry option is only selectable or displayed if said component is not assembled; and
a plurality of programmatic instructions stored in non-volatile memory, wherein said programmatic instructions, when executed by a processor, causes said quality level checks to be performed again on said component based upon a selection of said retry option.
